(19) United States
(12) Patent Application Publication
(10) Pub. No.: US 2026/0003133 A1
(43) Pub. Date: Jan. 1, 2026

(54) OPTICAL CONNECTOR CONNECTION DETERMINING APPARATUS

(71) Applicant: ADVANTEST CORPORATION, Tokyo (JP)

(72) Inventor: Hideo HARA, Miyagi (JP)

(73) Assignee: ADVANTEST CORPORATION, Tokyo (JP)

(21) Appl. No.: 19/211,483

(22) Filed: May 19, 2025

(30) Foreign Application Priority Data
Jul. 1, 2024 (JP) 2024-106124

(51) Int. Cl. G02B 6/38; G01M 11/08

(52) U.S. Cl. CPC G02B 6/385; G01M 11/085; G01M 11/088

(57) ABSTRACT

An optical connector connection determining apparatus includes a connection confirming laser beam source, that outputs a connection confirming laser beam to be used to confirm a connection between a first optical connector and a second optical connector. The apparatus further includes a connection confirming laser beam introducing section, that introduces the connection confirming laser beam into an introduction optical fiber, which is one of first optical fibers. The apparatus further includes a connection confirming laser beam extracting section, that extracts the connection confirming laser beam from an extraction optical fiber, which is one of the first optical fibers other than the introduction optical fiber. The apparatus further includes a connection determining section, that determines whether or not the connection between the first optical connector and the second optical connector is non-defective based on the connection confirming laser beam extracted through the connection confirming laser beam extracting section.

### BACKGROUND OF THE INVENTION

### Field of the Invention

The present invention relates to determining the connection of optical connectors.

### Description of the Related Art

There have conventionally been known monitoring breakage of an optical fiber (see Japanese Patent Application Publication No. 2006-033442, for example), detecting failure of an optical line (see Japanese Patent Application Publication No. 2009-103526, for example), and detecting failure of an excitation light source (see Japanese Patent Application Publication No. 2003-042899, for example).

### SUMMARY OF THE INVENTION

However, while impaired optical transmission can also be due to causes other than those above (e.g. defective optical connectors), the above-described related arts cannot detect defective optical connectors.

It is hence an object of the present invention to determine whether or not the connection of optical connectors is non-defective.

According to the present invention, an optical connector connection determining apparatus, includes: a first optical connector that retains first optical fibers; a second optical connector that retains second optical fibers to be connected with the first optical fibers and that is arranged to be connected with the first optical connector; a connection confirming laser beam source arranged to output a connection confirming laser beam to be used to confirm a connection between the first optical connector and the second optical connector; a connection confirming laser beam introducing section arranged to introduce the connection confirming laser beam into an introduction optical fiber, which is one of the first optical fibers; a connection confirming laser beam extracting section arranged to extract the connection confirming laser beam from an extraction optical fiber, which is one of the first optical fibers other than the introduction optical fiber; a connection determining section arranged to determine whether or not the connection between the first optical connector and the second optical connector is non-defective based on the connection confirming laser beam extracted through the connection confirming laser beam extracting section; a first connection confirming laser beam providing section arranged to receive the connection confirming laser beam from one intermediate optical fiber and provide to an other intermediate optical fiber, which are each one of the first optical fibers but not the introduction optical fiber or the extraction optical fiber; and a second connection confirming laser beam providing section arranged to receive the connection confirming laser beam from one of the second optical fibers and provide to another one of the second optical fibers, wherein the connection confirming laser beam passes through all of portions of the first optical fibers that are retained in the first optical connector and all of portions of the second optical fibers that are retained in the second optical connector.

According to the thus configured optical connector connection determining apparatus, a first optical connector retains first optical fibers. A second optical connector retains second optical fibers to be connected with the first optical fibers and is arranged to be connected with the first optical connector. A connection confirming laser beam source is arranged to output a connection confirming laser beam to be used to confirm a connection between the first optical connector and the second optical connector. A connection confirming laser beam introducing section is arranged to introduce the connection confirming laser beam into an introduction optical fiber, which is one of the first optical fibers. A connection confirming laser beam extracting section is arranged to extract the connection confirming laser beam from an extraction optical fiber, which is one of the first optical fibers other than the introduction optical fiber. A connection determining section is arranged to determine whether or not the connection between the first optical connector and the second optical connector is non-defective based on the connection confirming laser beam extracted through the connection confirming laser beam extracting section. A first connection confirming laser beam providing section is arranged to receive the connection confirming laser beam from one intermediate optical fiber and provide to an other intermediate optical fiber, which are each one of the first optical fibers but not the introduction optical fiber or the extraction optical fiber. A second connection confirming laser beam providing section is arranged to receive the connection confirming laser beam from one of the second optical fibers and provide to another one of the second optical fibers. The connection confirming laser beam passes through all of portions of the first optical fibers that are retained in the first optical connector and all of portions of the second optical fibers that are retained in the second optical connector.

According to the optical connector connection determining apparatus of the present invention, a wavelength-different laser beam with a wavelength different from that of the connection confirming laser beam may also pass through the first optical fibers and the second optical fibers.

According to the optical connector connection determining apparatus of the present invention, the connection confirming laser beam introducing section may be arranged to multiplex the connection confirming laser beam and the wavelength-different laser beam, and the connection confirming laser beam extracting section may be arranged to demultiplex the connection confirming laser beam and the wavelength-different laser beam.

According to the optical connector connection determining apparatus of the present invention, the connection confirming laser beam introducing section and the connection confirming laser beam extracting section may be wavelength division multiplexing couplers.

According to the optical connector connection determining apparatus of the present invention, the first connection confirming laser beam providing section may have: one first wavelength division multiplexing coupler mounted to the one intermediate optical fiber and arranged to demultiplex the connection confirming laser beam and the wavelength-different laser beam; and another first wavelength division multiplexing coupler mounted to the other intermediate optical fiber and arranged to multiplex the connection confirming laser beam and the wavelength-different laser beam, wherein the connection confirming laser beam demultiplexed through the one first wavelength division multiplexing coupler may be provided to the other first wavelength division multiplexing coupler.

According to the optical connector connection determining apparatus of the present invention, the first connection confirming laser beam providing section may have: a prism having a plane in contact with an end face of the one intermediate optical fiber and an end face of the other intermediate optical fiber, and two inclinations that intersect the plane and each other; and a filter mounted to the inclinations and arranged to cause the wavelength-different laser beam to penetrate therethrough better than the connection confirming laser beam, wherein the connection confirming laser beam may be emitted from the end face of the one intermediate optical fiber, reflected at the two inclinations, and made incident to the end face of the other intermediate optical fiber.

According to the optical connector connection determining apparatus of the present invention, the second connection confirming laser beam providing section may have: one second wavelength division multiplexing coupler mounted to the one second optical fiber and arranged to demultiplex the connection confirming laser beam and the wavelength-different laser beam; and an other second wavelength division multiplexing coupler mounted to the other second optical fiber and arranged to multiplex the connection confirming laser beam and the wavelength-different laser beam, wherein the connection confirming laser beam demultiplexed through the one second wavelength division multiplexing coupler may be provided to the other second wavelength division multiplexing coupler.

According to the optical connector connection determining apparatus of the present invention, the second connection confirming laser beam providing section may have: a prism having a plane in contact with an end face of the one second optical fiber and an end face of the other second optical fiber, and two inclinations that intersect the plane and each other; and a filter mounted to the inclinations and arranged to cause the wavelength-different laser beam to penetrate therethrough better than the connection confirming laser beam, wherein the connection confirming laser beam may be emitted from the end face of the one second optical fiber, reflected at the two inclinations, and made incident to the end face of the other second optical fiber.

According to the optical connector connection determining apparatus of the present invention, the one intermediate optical fiber and the other intermediate optical fiber may be adjacent to each other.

According to the optical connector connection determining apparatus of the present invention, the one second optical fiber and the other second optical fiber may be adjacent to each other.

According to the optical connector connection determining apparatus of the present invention, the first optical fibers may be connected to a test apparatus, the second optical fibers may be connected to an optical probe, and the wavelength-different laser beam may be transmitted between the test apparatus and the optical probe.

According to the optical connector connection determining apparatus of the present invention, the first optical connector and the second optical connector each may have an MT ferrule.

According to the optical connector connection determining apparatus of the present invention, the connection determining section may be arranged to determine whether or not the connection between the first optical connector and the second optical connector is non-defective based on a ratio between an optical power of an output from the connection confirming laser beam source and an optical power of the connection confirming laser beam extracted through the connection confirming laser beam extracting section.

### BRIEF DESCRIPTION OF THE DRAWINGS

FIG. 1 shows the configuration of an optical connector connection determining apparatus according to a first embodiment of the present invention;

FIG. 2 shows the configuration of an optical connector connection determining apparatus according to a second embodiment of the present invention;

FIG. 3 shows an optical connector connection determining apparatus according to a first variation of the first embodiment;

FIG. 4 shows an optical connector connection determining apparatus according to a second variation of the first embodiment;

FIG. 5 shows an optical connector connection determining apparatus according to a third variation of the first embodiment;

FIG. 6 shows an optical connector connection determining apparatus according to a fourth variation of the first embodiment; and

FIG. 7 shows an optical connector connection determining apparatus according to a fifth variation of the first embodiment.

### DESCRIPTION OF THE PREFERRED EMBODIMENT

Preferred embodiments of the present invention will hereinafter be described with reference to the accompanying drawings.

### First Embodiment

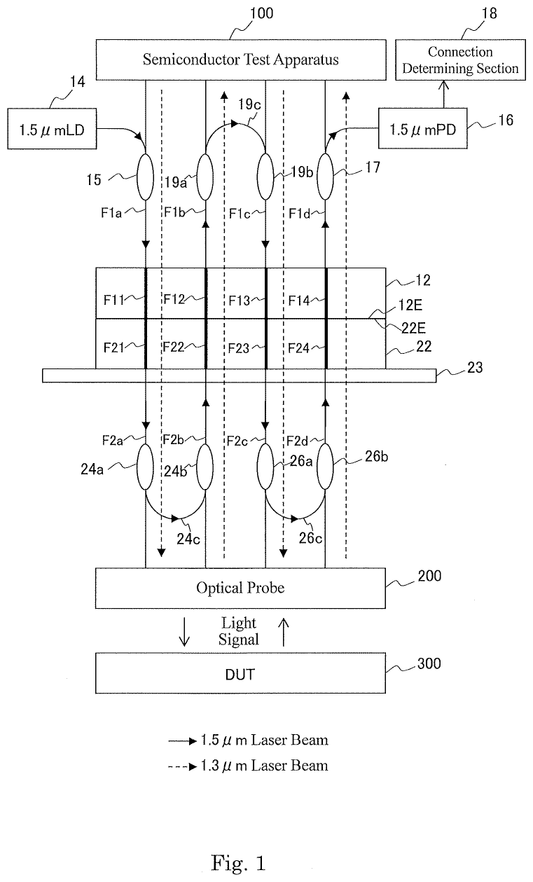

FIG. 1 shows the configuration of an optical connector connection determining apparatus according to a first embodiment of the present invention. The optical connector connection determining apparatus according to the first embodiment includes a semiconductor test apparatus 100, first optical fibers F1a, F1b, F1c, F1d, a first optical connector 12, a 1.5-μm LD (connection confirming laser beam source) 14, a connection confirming laser beam introducing section 15, a 1.5-μm PD (connection confirming laser beam detector) 16, a connection confirming laser beam extracting section 17, a connection determining section 18, a first connection confirming laser beam providing section (one first wavelength division multiplexing coupler 19a, another first wavelength division multiplexing coupler 19b, an optical fiber 19c), second optical fibers F2a, F2b, F2c, F2d, a second optical connector 22, a probe card 23, second connection confirming laser beam providing sections (one second wavelength division multiplexing coupler 24a, another second wavelength division multiplexing coupler 24b, an optical fiber 24c) (one second wavelength division multiplexing coupler 26a, another second wavelength division multiplexing coupler 26b, an optical fiber 26c), and an optical probe 200.

The semiconductor test apparatus 100 is a well-known semiconductor test apparatus for testing a DUT (Device Under Test) 300. For example, the DUT 300 is a semiconductor wafer. It is noted that the optical probe 200 is a well-known optical probe arranged to provide and receive a light signal to/from the DUT 300. Note here that the optical connector connection determining apparatus according to the first embodiment can be operated even when the DUT 300 is not operated.

The first optical fibers F1a, F1b, F1c, F1d are connected to the semiconductor test apparatus 100 and extend to an end face 12E of the first optical connector 12. End faces of the first optical fibers F1a, F1b, F1c, F1d are exposed at the end face 12E of the first optical connector 12.

The first optical connector 12 retains the first optical fibers F1a, F1b, F1c, F1d. Portions of the first optical fibers F1a, F1b, F1c, F1d that are retained in the first optical connector 12 are designated, respectively, by F11, F12, F13, F14.

The second optical fibers F2a, F2b, F2c, F2d are connected to the optical probe 200 and extend to an end face 22E of the second optical connector 22. End faces of the second optical fibers F2a, F2b, F2c, F2d are exposed at the end face 22E of the second optical connector 22.

The first optical connector 12 and the second optical connector 22 are connected such that the end face 12E of the first optical connector 12 and the end face 22E of the second optical connector 22 come into contact with each other. This connection causes the end faces of the first optical fibers F1a, F1b, F1c, F1d and the end faces of the second optical fibers F2a, F2b, F2c, F2d to come into contact with each other. The second optical fibers F2a, F2b, F2c, F2d are thus connected with the first optical fibers F1a, F1b, F1c, F1d.

The second optical connector 22 retains the second optical fibers F2a, F2b, F2c, F2d. Portions of the second optical fibers F2a, F2b, F2c, F2d that are retained in the second optical connector 22 are designated, respectively, by F21, F22, F23, F24.

It is noted that the first optical connector 12 and the second optical connector 22 each have an MT ferrule. For example, the first optical connector 12 and the second optical connector 22 may each be an MT ferrule or a connector with an MT ferrule stored therein (e.g. Blindmate connector).

The second optical connector 22 is disposed on a first surface of the probe card 23, while the optical probe 200 is disposed on a second surface of the probe card 23. Note here that for illustrative purposes, the optical probe 200 is shown apart from the second surface of the probe card 23.

The 1.5-μm LD (connection confirming laser beam source) 14 is arranged to output a connection confirming laser beam (with a wavelength of 1.5 μm) to be used to confirm the connection between the first optical connector 12 and the second optical connector 22.

A wavelength-different laser beam with a wavelength (of 1.3 μm) different from that (1.5 μm) of the connection confirming laser beam also passes through the first optical fibers F1a, F1b, F1c, F1d and the second optical fibers F2a, F2b, F2c, F2d.

The wavelength-different laser beam is a semiconductor testing laser beam transmitted between the semiconductor test apparatus 100 and the optical probe 200. For example, the wavelength-different laser beam is transmitted from the semiconductor test apparatus 100 through the first optical fiber F1a and the second optical fiber F2a to the optical probe 200. The wavelength-different laser beam is transmitted from the semiconductor test apparatus 100 through the first optical fiber F1c and the second optical fiber F2c to the optical probe 200. The wavelength-different laser beam is transmitted from the optical probe 200 through the first optical fiber Fib and the second optical fiber F2b to the semiconductor test apparatus 100. The wavelength-different laser beam is transmitted from the optical probe 200 through the first optical fiber F1d and the second optical fiber F2d to the semiconductor test apparatus 100.

The connection confirming laser beam introducing section 15 is arranged to introduce the connection confirming laser beam (with a wavelength of 1.5 μm) received from the 1.5-μm LD 14 into an introduction optical fiber (the first optical fiber F1a in FIG. 1), which is one of the first optical fibers F1a, F1b, F1c, F1d. The connection confirming laser beam introducing section 15 is, for example, a wavelength division multiplexing coupler arranged to multiplex the connection confirming laser beam (with a wavelength of 1.5 μm) and the wavelength-different laser beam (with a wavelength of 1.3 μm).

The connection confirming laser beam extracting section 17 is arranged to extract the connection confirming laser beam (with a wavelength of 1.5 μm) from an extraction optical fiber (the first optical fiber F1d in FIG. 1), which is one of the first optical fibers F1a, F1b, F1c, F1d other than the introduction optical fiber (first optical fiber F1a in FIG. 1). The connection confirming laser beam extracting section 17 is, for example, a wavelength division multiplexing coupler arranged to demultiplex the connection confirming laser beam (with a wavelength of 1.5 μm) and the wavelength-different laser beam (with a wavelength of 1.3 μm).

The 1.5-μm PD (connection confirming laser beam detector) 16 is a photodetector arranged to detect the connection confirming laser beam that is extracted from the extraction optical fiber (the first optical fiber F1d in FIG. 1) through the connection confirming laser beam extracting section 17. The 1.5-μm PD 16 can then measure the optical power of the connection confirming laser beam extracted through the connection confirming laser beam extracting section 17.

The first connection confirming laser beam providing section (having one first wavelength division multiplexing coupler 19a, another first wavelength division multiplexing coupler 19b, and optical fiber 19c) is arranged to receive the connection confirming laser beam from one intermediate optical fiber Fib and provide to another intermediate optical fiber F1c, which are each one of the first optical fibers F1a, F1b, F1c, F1d but not the introduction optical fiber F1a or the extraction optical fiber F1d.

The one first wavelength division multiplexing coupler 19a is mounted to the one intermediate optical fiber F1b and arranged to demultiplex the connection confirming laser beam and the wavelength-different laser beam. The other first wavelength division multiplexing coupler 19b is mounted to the other intermediate optical fiber F1c and arranged to multiplex the connection confirming laser beam and the wavelength-different laser beam. The connection confirming laser beam demultiplexed through the one first wavelength division multiplexing coupler 19a is provided through the optical fiber 19c to the other first wavelength division multiplexing coupler 19b.

It is noted that the one intermediate optical fiber F1b and the other intermediate optical fiber F1c are adjacent to each other.

There are provided two second connection confirming laser beam providing sections.

The first one of the second connection confirming laser beam providing sections (having one second wavelength division multiplexing coupler 24a, another second wavelength division multiplexing coupler 24b, an optical fiber 24c) is arranged to receive the connection confirming laser beam from one of the second optical fibers F2a and provide to another one of the second optical fibers F2b.

The one second wavelength division multiplexing coupler 24a is mounted to the one second optical fiber F2a and arranged to demultiplex the connection confirming laser beam and the wavelength-different laser beam. The other second wavelength division multiplexing coupler 24b is mounted to the other second optical fiber F2b and arranged to multiplex the connection confirming laser beam and the wavelength-different laser beam. The connection confirming laser beam demultiplexed through the one second wavelength division multiplexing coupler 24a is provided through the optical fiber 24c to the other second wavelength division multiplexing coupler 24b.

It is noted that the one second optical fiber F2a and the other second optical fiber F2b are adjacent to each other.

The second one of the second connection confirming laser beam providing sections (having one second wavelength division multiplexing coupler 26a, another second wavelength division multiplexing coupler 26b, an optical fiber 26c) is arranged to receive the connection confirming laser beam from one of the second optical fibers F2c and provide to another one of the second optical fibers F2d.

The one second wavelength division multiplexing coupler 26a is mounted to the one second optical fiber F2c and arranged to demultiplex the connection confirming laser beam and the wavelength-different laser beam. The other second wavelength division multiplexing coupler 26b is mounted to the other second optical fiber F2d and arranged to multiplex the connection confirming laser beam and the wavelength-different laser beam. The connection confirming laser beam demultiplexed through the one second wavelength division multiplexing coupler 26a is provided through the optical fiber 26c to the other second wavelength division multiplexing coupler 26b.

It is noted that the one second optical fiber F2c and the other second optical fiber F2d are adjacent to each other.

The connection confirming laser beam thus passes through all of the portions F11, F12, F13, F14 of the first optical fibers F1a, F1b, F1c, F1d that are retained in the first optical connector 12 and all of the portions F21, F22, F23, F24 of the second optical fibers F2a, F2b, F2c, F2d that are retained in the second optical connector 22.

That is, the connection confirming laser beam is introduced through the connection confirming laser beam introducing section 15 into the introduction optical fiber (first optical fiber F1a in FIG. 1) and then passes through F11, F21, F22, F12, F13, F23, F24, F14 in this order.

The connection determining section 18 is arranged to determine whether or not the connection between the first optical connector 12 and the second optical connector 22 is non-defective based on the connection confirming laser beam extracted through the connection confirming laser beam extracting section 17.

For example, the connection determining section 18 is arranged to receive, from the 1.5-μm PD 16, a measurement result on the optical power of the connection confirming laser beam extracted through the connection confirming laser beam extracting section 17. The connection determining section 18 is further arranged to determine whether or not the connection between the first optical connector 12 and the second optical connector 22 is non-defective based on the ratio between the optical power of an output from the connection confirming laser beam source 14 and the optical power of the connection confirming laser beam extracted through the connection confirming laser beam extracting section 17.

For example, when the optical power of the connection confirming laser beam extracted through the connection confirming laser beam extracting section 17 is approximately equal to (or considerably lower than) the optical power of the output from the connection confirming laser beam source 14, it is determined that the connection between the first optical connector 12 and the second optical connector 22 is non-defective (or defective).

Next will be described an operation according to the first embodiment.

First, the first optical fibers F1a, F1b, F1c, F1d connected to the semiconductor test apparatus 100 are retained in the first optical connector 12. The second optical fibers F2a, F2b, F2c, F2d connected to the optical probe 200 are retained in the second optical connector 22.

Further, the end face 12E of the first optical connector 12 and the end face 22E of the second optical connector 22 are brought into contact with each other to connect the first optical connector 12 and the second optical connector 22. This connection causes the end faces of the first optical fibers F1a, F1b, F1c, F1d and the end faces of the second optical fibers F2a, F2b, F2c, F2d to come into contact with each other. The second optical fibers F2a, F2b, F2c, F2d are thus connected with the first optical fibers F1a, F1b, F1c, F1d.

Here, a wavelength-different laser beam (with a wavelength of 1.3 μm) is transmitted between the semiconductor test apparatus 100 and the optical probe 200 through the first optical fibers F1a, F1b, F1c, F1d and the second optical fibers F2a, F2b, F2c, F2d.

For example, the wavelength-different laser beam is transmitted from the semiconductor test apparatus 100 through the first optical fiber F1a and the second optical fiber F2a (or the first optical fiber F1c and the second optical fiber F2c) to the optical probe 200.

A wavelength-different laser beam is also transmitted from the optical probe 200 through the first optical fiber F1b and the second optical fiber F2b (or the first optical fiber F1d and the second optical fiber F2d) to the semiconductor test apparatus 100.

It is noted that a light signal is transmitted between the optical probe 200 and the DUT 300.

Further, a connection confirming laser beam (with a wavelength of 1.5 μm) output from the 1.5-μm LD 14 is introduced through the connection confirming laser beam introducing section 15 into the introduction optical fiber (first optical fiber F1a in FIG. 1).

The connection confirming laser beam then passes through F11 and F21 and reaches the one second wavelength division multiplexing coupler 24a. When reaching the one second wavelength division multiplexing coupler 24a, the connection confirming laser beam then reaches the other second wavelength division multiplexing coupler 24b through the optical fiber 24c and is provided to the other second optical fiber F2b.

The connection confirming laser beam then passes through F22 and F12 and reaches the one first wavelength division multiplexing coupler 19a. When reaching the one first wavelength division multiplexing coupler 19a, the connection confirming laser beam then reaches the other first wavelength division multiplexing coupler 19b through the optical fiber 19c and is provided to the other intermediate optical fiber F1c.

The connection confirming laser beam then passes through F13 and F23 and reaches the one second wavelength division multiplexing coupler 26a. When reaching the one second wavelength division multiplexing coupler 26a, the connection confirming laser beam then reaches the other second wavelength division multiplexing coupler 26b through the optical fiber 26c and is provided to the other second optical fiber F2d.

The connection confirming laser beam then passes through F24 and F14 and reaches the connection confirming laser beam extracting section 17. The optical power of the connection confirming laser beam extracted through the connection confirming laser beam extracting section 17 is measured by the 1.5-μm PD 16 and the result is provided to the connection determining section 18. The connection determining section 18 determines whether or not the connection between the first optical connector 12 and the second optical connector 22 is non-defective based on the ratio between the measurement result and the optical power of the output from the connection confirming laser beam source 14.

For example, when the measurement result is approximately equal to the optical power of the output from the connection confirming laser beam source 14, it is determined that the connection between the first optical connector 12 and the second optical connector 22 is non-defective.

It is here assumed that dust on the end face of F11 causes defective connection between the end face of F11 and the end face of F21, for example. In this case, the measurement result by the 1.5-μm PD 16 is considerably lower than the optical power of the output from the connection confirming laser beam source 14. The connection determining section 18 then determines that the connection between the first optical connector 12 and the second optical connector 22 is defective.

It will be appreciated that not only when the connection between the end face of F11 and the end face of F21 is defective, but also when the connection between the end face of F12 and the end face of F22 is defective, when the connection between the end face of F13 and the end face of F23 is defective, and/or when the connection between the end face of F14 and the end face of F24 is defective, the measurement result by the 1.5-μm PD 16 may be considerably lower than the optical power of the output from the connection confirming laser beam source 14. That is, while it is recognized that the connection between the first optical connector 12 and the second optical connector 22 is defective, it cannot be recognized at which optical fiber the connection is defective. However, this is no problem because when it is recognized that the connection between the first optical connector 12 and the second optical connector 22 is defective, it is only required to replace the first optical connector 12 and the second optical connector 22 with different ones to provide good connection between the first optical connector 12 and the second optical connector 22.

It is noted that the above description of the operation according to the first embodiment is for the case where the DUT 300 is operated. However, even when the DUT 300 is not operated and further even when no wavelength-different laser beam is transmitted between the semiconductor test apparatus 100 and the optical probe 200, the optical connector connection determining apparatus can operate using the connection confirming laser beam. That is, it can be determined whether or not the connection between the first optical connector 12 and the second optical connector 22 is non-defective.

In accordance with the first embodiment, it is possible to determine whether or not the connection between the first optical connector 12 and the second optical connector 22 is non-defective.

It is noted that even when the DUT 300 is operated and further even when a wavelength-different laser beam is transmitted between the semiconductor test apparatus 100 and the optical probe 200, the determination can be made. Alternatively, even when the DUT 300 is not operated and further even when no wavelength-different laser beam is transmitted between the semiconductor test apparatus 100 and the optical probe 200, the determination can be made.

It is noted that the first embodiment may include the following variations.

### <First Variation>

In the first embodiment, the one second optical fiber F2a (or F2c) and the other second optical fiber F2b (or F2d) are adjacent to each other. In contrast, in a first variation of the first embodiment, the one second optical fiber F2a (or F2b) and the other second optical fiber F2c (or F2d) are not adjacent to each other.

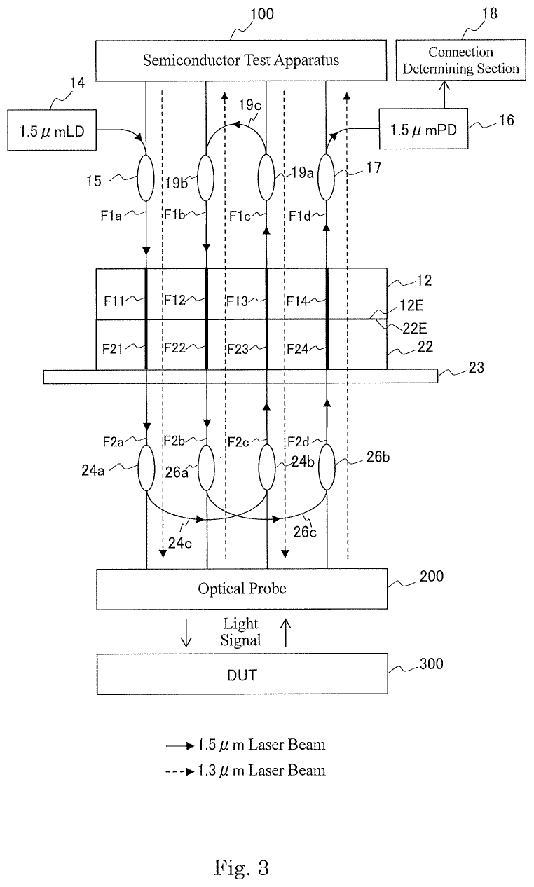

FIG. 3 shows an optical connector connection determining apparatus according to the first variation of the first embodiment. It is noted that components identical to those in the first embodiment will be designated by the same symbols to omit the description thereof.

The first one of the second connection confirming laser beam providing sections (having one second wavelength division multiplexing coupler 24a, another second wavelength division multiplexing coupler 24b, an optical fiber 24c) is arranged to receive the connection confirming laser beam from one of the second optical fibers F2a and provide to another one of the second optical fibers F2c.

The one second wavelength division multiplexing coupler 24a is mounted to the one second optical fiber F2a and arranged to demultiplex the connection confirming laser beam and the wavelength-different laser beam. The other second wavelength division multiplexing coupler 24b is mounted to the other second optical fiber F2c and arranged to multiplex the connection confirming laser beam and the wavelength-different laser beam. The connection confirming laser beam demultiplexed through the one second wavelength division multiplexing coupler 24a is provided through the optical fiber 24c to the other second wavelength division multiplexing coupler 24b.

It is noted that the one second optical fiber F2a and the other second optical fiber F2c are not adjacent to each other.

The second one of the second connection confirming laser beam providing sections (having one second wavelength division multiplexing coupler 26a, another second wavelength division multiplexing coupler 26b, an optical fiber 26c) is arranged to receive the connection confirming laser beam from one of the second optical fibers F2b and provide to another one of the second optical fibers F2d.

The one second wavelength division multiplexing coupler 26a is mounted to the one second optical fiber F2b and arranged to demultiplex the connection confirming laser beam and the wavelength-different laser beam. The other second wavelength division multiplexing coupler 26b is mounted to the other second optical fiber F2d and arranged to multiplex the connection confirming laser beam and the wavelength-different laser beam. The connection confirming laser beam demultiplexed through the one second wavelength division multiplexing coupler 26a is provided through the optical fiber 26c to the other second wavelength division multiplexing coupler 26b.

It is noted that the one second optical fiber F2b and the other second optical fiber F2d are not adjacent to each other.

Here, the first connection confirming laser beam providing section (having one first wavelength division multiplexing coupler 19a, another first wavelength division multiplexing coupler 19b, an optical fiber 19c) is arranged to receive the connection confirming laser beam from one intermediate optical fiber F1c and provide to another intermediate optical fiber F1b.

The one first wavelength division multiplexing coupler 19a is mounted to the one intermediate optical fiber F1c and arranged to demultiplex the connection confirming laser beam and the wavelength-different laser beam. The other first wavelength division multiplexing coupler 19b is mounted to the other intermediate optical fiber F1b and arranged to multiplex the connection confirming laser beam and the wavelength-different laser beam. The connection confirming laser beam demultiplexed through the one first wavelength division multiplexing coupler 19a is provided through the optical fiber 19c to the other first wavelength division multiplexing coupler 19b.

Also, the connection confirming laser beam is introduced through the connection confirming laser beam introducing section 15 into the introduction optical fiber (first optical fiber F1a in FIG. 3) and then passes through F11, F21, F23, F13, F12, F22, F24, F14 in this order.

### <Second Variation>

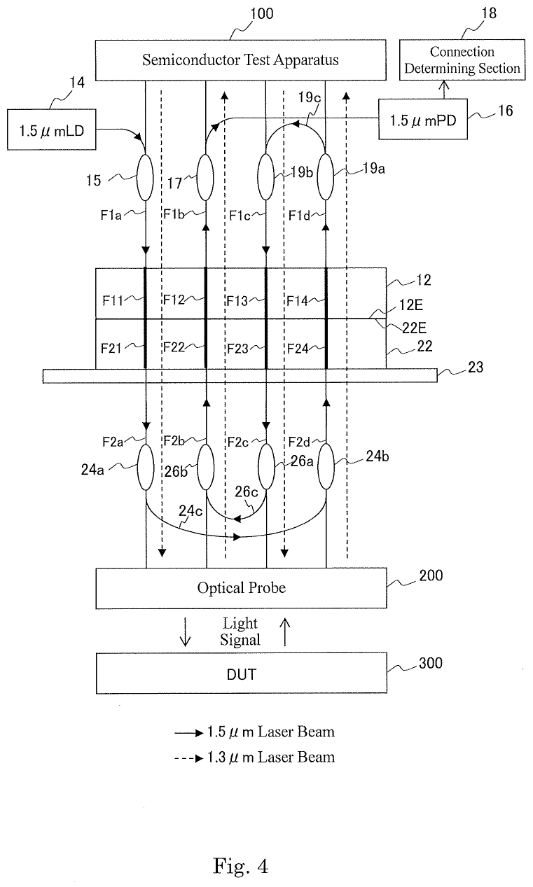

In the first embodiment, the extraction optical fiber (first optical fiber F1d in FIG. 1) is the rightmost one of the first optical fibers F1a, F1b, F1c, F1d. In contrast, in a second variation of the first embodiment, the extraction optical fiber (first optical fiber F1b in FIG. 4) is not the rightmost one of the first optical fibers F1a, F1b, F1c, F1d.

FIG. 4 shows an optical connector connection determining apparatus according to the second variation of the first embodiment. It is noted that components identical to those in the first embodiment will be designated by the same symbols to omit the description thereof.

The connection confirming laser beam extracting section 17 is arranged to extract the connection confirming laser beam (with a wavelength of 1.5 μm) from an extraction optical fiber (the first optical fiber F1b in FIG. 4).

It is noted that the one first wavelength division multiplexing coupler 19a is mounted to the one intermediate optical fiber F1d. The other first wavelength division multiplexing coupler 19b is mounted to the other intermediate optical fiber F1c.

Also, the one second wavelength division multiplexing coupler 24a is mounted to the one second optical fiber F2a. The other second wavelength division multiplexing coupler 24b is mounted to the other second optical fiber F2d.

Further, the one second wavelength division multiplexing coupler 26a is mounted to the one second optical fiber F2c. The other second wavelength division multiplexing coupler 26b is mounted to the other second optical fiber F2b.

Also, the connection confirming laser beam is introduced through the connection confirming laser beam introducing section 15 into the introduction optical fiber (first optical fiber F1a in FIG. 4) and then passes through F11, F21, F24, F14, F13, F23, F22, F12 in this order.

### <Third Variation>

While there are four first optical fibers F1a, F1b, F1c, F1d and four second optical fibers F2a, F2b, F2c, F2d in the first embodiment, the number may be another even of six or more.

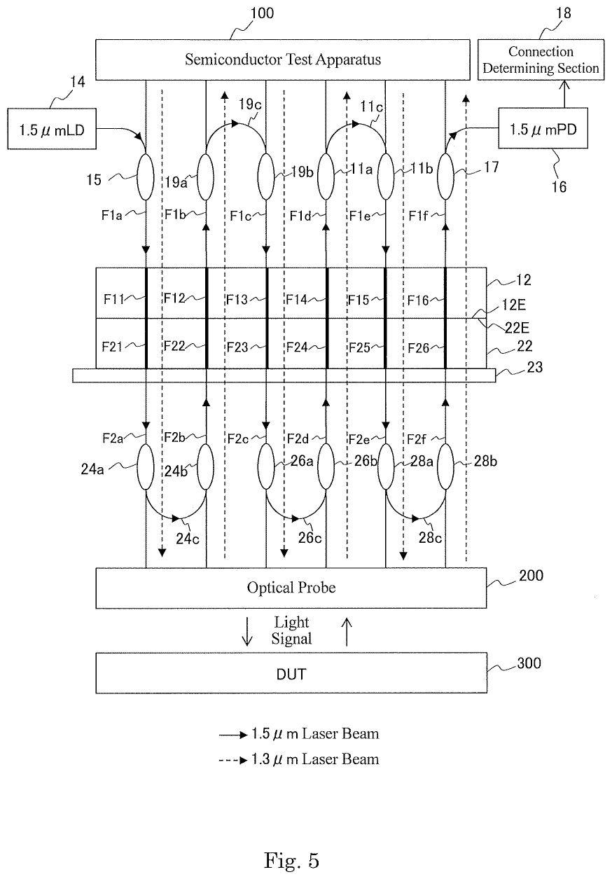

FIG. 5 shows an optical connector connection determining apparatus according to a third variation of the first embodiment. It is noted that components identical to those in the first embodiment will be designated by the same symbols to omit the description thereof. There are six first optical fibers F1a, F1b, F1c, F1d, F1e, F1f and six second optical fibers F2a, F2b, F2c, F2d, F2e, F2f.

A wavelength-different laser beam (with a wavelength of 1.3 μm) is transmitted between the semiconductor test apparatus 100 and the optical probe 200 through the first optical fibers F1a, F1b, F1c, F1d, F1e, F1f and the second optical fibers F2a, F2b, F2c, F2d, F2e, F2f.

For example, the wavelength-different laser beam is transmitted from the semiconductor test apparatus 100 through the first optical fiber F1e and the second optical fiber F2e to the optical probe 200.

Also, the wavelength-different laser beam is transmitted from the optical probe 200 through the first optical fiber F1f and the second optical fiber F2f to the semiconductor test apparatus 100.

Note here that the first optical fiber F1f serves as an extraction optical fiber.

The second one of the first connection confirming laser beam providing sections (having one first wavelength division multiplexing coupler 11a, another first wavelength division multiplexing coupler 11b, and optical fiber 11c) is arranged to receive the connection confirming laser beam from one intermediate optical fiber F1d and provide to another intermediate optical fiber F1e, which are each one of the first optical fibers F1a, F1b, F1c, F1d, F1e, F1f but not the introduction optical fiber F1a or the extraction optical fiber F1f.

The second one first wavelength division multiplexing coupler 11a is mounted to the one intermediate optical fiber F1d and arranged to demultiplex the connection confirming laser beam and the wavelength-different laser beam. The other first wavelength division multiplexing coupler 11b is mounted to the other intermediate optical fiber F1e and arranged to multiplex the connection confirming laser beam and the wavelength-different laser beam. The connection confirming laser beam demultiplexed through the one first wavelength division multiplexing coupler 11a is provided through the optical fiber 11c to the other first wavelength division multiplexing coupler 11b.

The third one of the second connection confirming laser beam providing sections (having one second wavelength division multiplexing coupler 28a, another second wavelength division multiplexing coupler 28b, an optical fiber 28c) is arranged to receive the connection confirming laser beam from one of the second optical fibers F2e and provide to another one of the second optical fibers F2f.

The one second wavelength division multiplexing coupler 28a is mounted to the one second optical fiber F2e and arranged to demultiplex the connection confirming laser beam and the wavelength-different laser beam. The other second wavelength division multiplexing coupler 28b is mounted to the other second optical fiber F2f and arranged to multiplex the connection confirming laser beam and the wavelength-different laser beam. The connection confirming laser beam demultiplexed through the one second wavelength division multiplexing coupler 28a is provided through the optical fiber 28c to the other second wavelength division multiplexing coupler 28b.

Also, the connection confirming laser beam is introduced through the connection confirming laser beam introducing section 15 into the introduction optical fiber (first optical fiber F1a in FIG. 5) and then passes through F11, F21, F22, F12, F13, F23, F24, F14, F15, F25, F26, F16 in this order.

### <Fourth Variation>

In the first embodiment and the third variation thereof, the one intermediate optical fiber F1b (or F1d) and the other intermediate optical fiber F1c (or F1e) are adjacent to each other. In contrast, in a fourth variation of the first embodiment, the one intermediate optical fiber F1b (or F1c) and the other intermediate optical fiber F1d (or F1e) are not adjacent to each other.

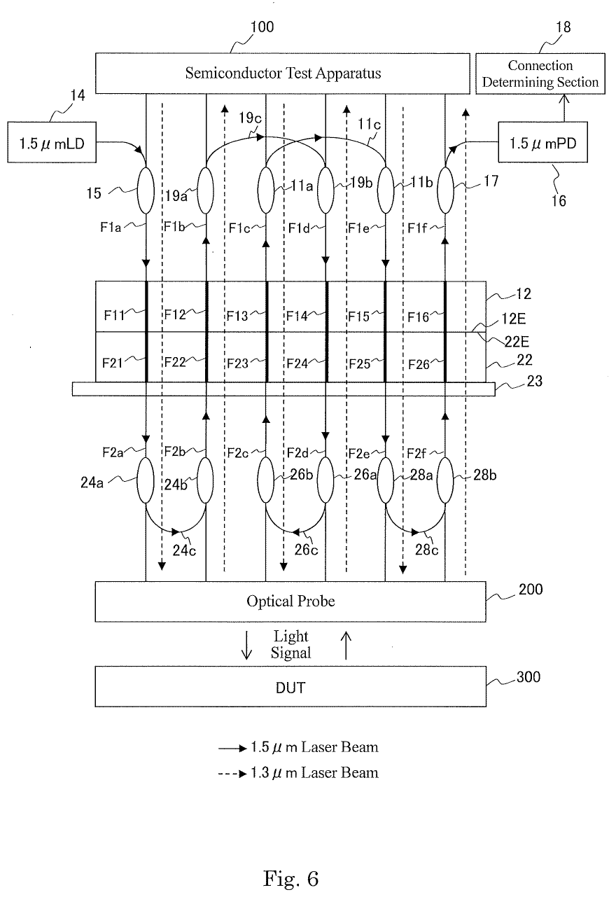

FIG. 6 shows an optical connector connection determining apparatus according to the fourth variation of the first embodiment. It is noted that components identical to those in the third variation of the first embodiment will be designated by the same symbols to omit the description thereof.

The first connection confirming laser beam providing section (having one first wavelength division multiplexing coupler 19a, another first wavelength division multiplexing coupler 19b, and optical fiber 19c) is arranged to receive the connection confirming laser beam from one intermediate optical fiber F1b and provide to another intermediate optical fiber F1d, which are each one of the first optical fibers F1a, F1b, F1c, F1d but not the introduction optical fiber F1a or the extraction optical fiber F1d.

The one first wavelength division multiplexing coupler 19a is mounted to the one intermediate optical fiber F1b and arranged to demultiplex the connection confirming laser beam and the wavelength-different laser beam. The other first wavelength division multiplexing coupler 19b is mounted to the other intermediate optical fiber F1d and arranged to multiplex the connection confirming laser beam and the wavelength-different laser beam. The connection confirming laser beam demultiplexed through the one first wavelength division multiplexing coupler 19a is provided through the optical fiber 19c to the other first wavelength division multiplexing coupler 19b.

It is noted that the one intermediate optical fiber Fib and the other intermediate optical fiber F1d are not adjacent to each other.

The second one first wavelength division multiplexing coupler 11a is mounted to the one intermediate optical fiber F1c and arranged to demultiplex the connection confirming laser beam and the wavelength-different laser beam. The other first wavelength division multiplexing coupler 11b is mounted to the other intermediate optical fiber F1e and arranged to multiplex the connection confirming laser beam and the wavelength-different laser beam. The connection confirming laser beam demultiplexed through the one first wavelength division multiplexing coupler 11a is provided through the optical fiber 11c to the other first wavelength division multiplexing coupler 11b.

It is noted that the one intermediate optical fiber F1c and the other intermediate optical fiber F1e are not adjacent to each other.

The second one of the second connection confirming laser beam providing sections (having one second wavelength division multiplexing coupler 26a, another second wavelength division multiplexing coupler 26b, an optical fiber 26c) is arranged to receive the connection confirming laser beam from one of the second optical fibers F2d and provide to another one of the second optical fibers F2c.

The one second wavelength division multiplexing coupler 26a is mounted to the one second optical fiber F2d and arranged to demultiplex the connection confirming laser beam and the wavelength-different laser beam. The other second wavelength division multiplexing coupler 26b is mounted to the other second optical fiber F2c and arranged to multiplex the connection confirming laser beam and the wavelength-different laser beam. The connection confirming laser beam demultiplexed through the one second wavelength division multiplexing coupler 26a is provided through the optical fiber 26c to the other second wavelength division multiplexing coupler 26b.

Also, the connection confirming laser beam is introduced through the connection confirming laser beam introducing section 15 into the introduction optical fiber (first optical fiber F1a in FIG. 6) and then passes through F11, F21, F22, F12, F14, F24, F23, F13, F15, F25, F26, F16 in this order.

### <Fifth Variation>

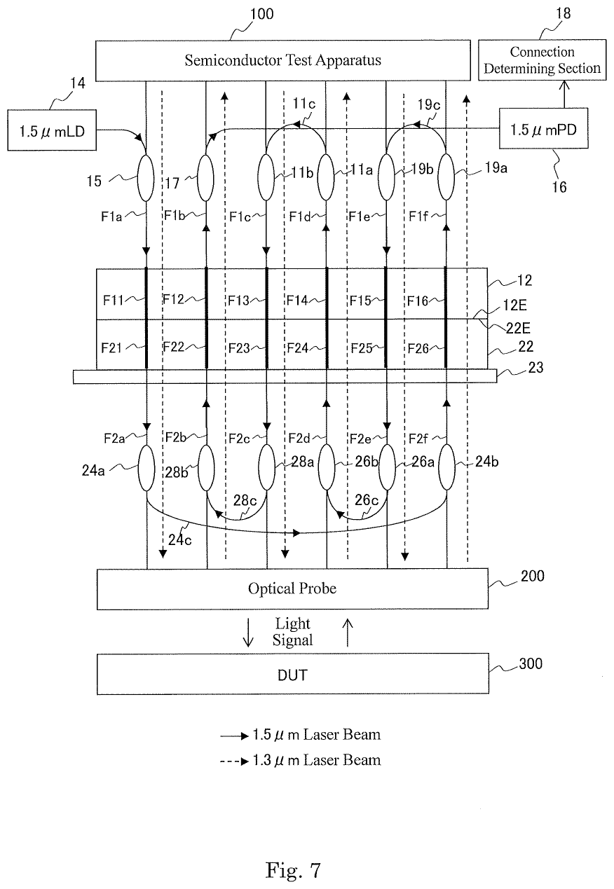

In the third variation of the first embodiment, the extraction optical fiber (first optical fiber F1f in FIG. 5) is the rightmost one of the first optical fibers F1a, F1b, F1c, F1d, F1e, F1f. In contrast, in a fifth variation of the first embodiment, the extraction optical fiber (first optical fiber F1b in FIG. 7) is not the rightmost one of the first optical fibers F1a, F1b, F1c, F1d, F1e, F1f. Additionally, in the fifth variation of the first embodiment, the one second optical fiber F2a and the other second optical fiber F2f are not adjacent to each other.

FIG. 7 shows an optical connector connection determining apparatus according to the fifth variation of the first embodiment. It is noted that components identical to those in the third variation of the first embodiment will be designated by the same symbols to omit the description thereof.

The connection confirming laser beam extracting section 17 is arranged to extract the connection confirming laser beam (with a wavelength of 1.5 μm) from an extraction optical fiber (the first optical fiber F1b in FIG. 7).

It is noted that the one first wavelength division multiplexing coupler 19a is mounted to the one intermediate optical fiber F1f. The other first wavelength division multiplexing coupler 19b is mounted to the other intermediate optical fiber F1e.

Also, the one first wavelength division multiplexing coupler 11a is mounted to the one intermediate optical fiber F1d. The other first wavelength division multiplexing coupler 11b is mounted to the other intermediate optical fiber F1c.

It is noted that the one second wavelength division multiplexing coupler 24a is mounted to the one second optical fiber F2a. The other second wavelength division multiplexing coupler 24b is mounted to the other second optical fiber F2f.

Also, the one second wavelength division multiplexing coupler 26a is mounted to the one second optical fiber F2e. The other second wavelength division multiplexing coupler 26b is mounted to the other second optical fiber F2d.

Further, the one second wavelength division multiplexing coupler 28a is mounted to the one second optical fiber F2c. The other second wavelength division multiplexing coupler 28b is mounted to the other second optical fiber F2b.

The connection confirming laser beam is introduced through the connection confirming laser beam introducing section 15 into the introduction optical fiber (first optical fiber F1a in FIG. 7) and then passes through F11, F21, F26, F16, F15, F25, F24, F14, F13, F23, F22, F12 in this order.

### Second Embodiment

A second embodiment differs from the first embodiment in that a prism 120 and filters 122a, 122b are used as a first connection confirming laser beam providing section and that a prism 220 and filters 222a, 222b as well as a prism 240 and filters 242a, 242b are used as a second connection confirming laser beam providing section.

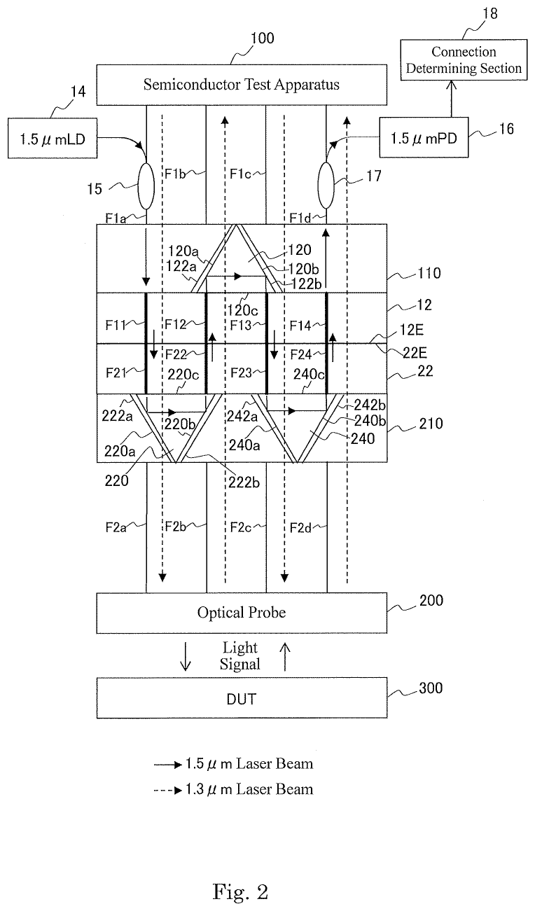

FIG. 2 shows the configuration of an optical connector connection determining apparatus according to the second embodiment of the present invention. The optical connector connection determining apparatus according to the second embodiment includes a semiconductor test apparatus 100, first optical fibers F1a, F1b, F1c, F1d, a first optical connector 12, a 1.5-μm LD (connection confirming laser beam source) 14, a connection confirming laser beam introducing section 15, a 1.5-μm PD (connection confirming laser beam detector) 16, a connection confirming laser beam extracting section 17, a connection determining section 18, a first connection confirming laser beam providing section (a prism 120, filters 122a, 122b), a transparent member 110, second optical fibers F2a, F2b, F2c, F2d, a second optical connector 22, a probe card 23, second connection confirming laser beam providing sections (a prism 220, filters 222a, 222b) (a prism 240, filters 242a, 242b), a transparent member 210, and an optical probe 200. Components identical to those in the first embodiment will be designated by the same symbols to omit the description thereof.

The transparent member 110 is in contact with the first optical connector 12. The transparent member 110 is disposed between the semiconductor test apparatus 100 and the first optical connector 12. The first optical fibers F1a, F1b, F1c, F1d extend from the semiconductor test apparatus 100 to the end face 12E of the first optical connector 12 as is the case in the first embodiment, but discontinued with the transparent member 110. It is noted that the connection confirming laser beam (with a wavelength of 1.5 μm) and the wavelength-different laser beam (with a wavelength of 1.3 μm) pass through the transparent member 110.

The first connection confirming laser beam providing section (having a prism 120, filters 122a, 122b) is disposed within the transparent member 110.

The prism 120 has a plane 120c and two inclinations 120a, 120b. The plane 120c is in contact with an end face (of the portion F12 that is retained in the first optical connector 12) of the one intermediate optical fiber Fib and an end face (of the portion F13 that is retained in the first optical connector 12) of the other intermediate optical fiber F1c. The two inclinations 120a, 120b intersect the plane 120c and each other.

The filter 122a is mounted to the inclination 120a and arranged to cause the wavelength-different laser beam to penetrate therethrough better than the connection confirming laser beam. The filter 122b is mounted to the inclination 120b and arranged to cause the wavelength-different laser beam to penetrate therethrough better than the connection confirming laser beam. It is noted that the filters 122a and 122b are each formed as, for example, a thin film.

The connection confirming laser beam is emitted from the end face (of the portion F12 that is retained in the first optical connector 12) of the one intermediate optical fiber F1b, reflected at the two inclinations 120a, 120b, and made incident to the end face (of the portion F13 that is retained in the first optical connector 12) of the other intermediate optical fiber F1c.

The transparent member 210 is in contact with the second optical connector 22. The transparent member 210 is disposed between the optical probe 200 and the second optical connector 22. The second optical fibers F2a, F2b, F2c, F2d extend from the optical probe 200 to the end face 22E of the second optical connector 22 as is the case in the first embodiment, but discontinued with the transparent member 210. It is noted that the connection confirming laser beam (with a wavelength of 1.5 μm) and the wavelength-different laser beam (with a wavelength of 1.3 μm) pass through the transparent member 210.

The first one of the second connection confirming laser beam providing sections (a prism 220, filters 222a, 222b) is disposed within the transparent member 210.

The prism 220 has a plane 220c and two inclinations 220a, 220b. The plane 220c is in contact with an end face (of the portion F121 that is retained in the second optical connector 22) of the one second optical fiber F2a and an end face (of the portion F22 that is retained in the second optical connector 22) of the other second optical fiber F2b. The two inclinations 220a, 220b intersect the plane 220c and each other.

The filter 222a is mounted to the inclination 220a and arranged to cause the wavelength-different laser beam to penetrate therethrough better than the connection confirming laser beam. The filter 222b is mounted to the inclination 220b and arranged to cause the wavelength-different laser beam to penetrate therethrough better than the connection confirming laser beam. It is noted that the filters 222a and 222b are each formed as, for example, a thin film.

The connection confirming laser beam is emitted from the end face (of the portion F21 that is retained in the second optical connector 22) of the one second optical fiber F2a, reflected at the two inclinations 220a, 220b, and made incident to the end face (of the portion F22 that is retained in the second optical connector 22) of the other second optical fiber F2b.

The second one of the second connection confirming laser beam providing sections (a prism 240, filters 242a, 242b) is disposed within the transparent member 210.

The prism 240 has a plane 240c and two inclinations 240a, 240b. The plane 240c is in contact with an end face (of the portion F23 that is retained in the second optical connector 22) of the one second optical fiber F2c and an end face (of the portion F24 that is retained in the second optical connector 22) of the other second optical fiber F2d. The two inclinations 240a, 240b intersect the plane 240c and each other.

The filter 242a is mounted to the inclination 240a and arranged to cause the wavelength-different laser beam to penetrate therethrough better than the connection confirming laser beam. The filter 242b is mounted to the inclination 240b and arranged to cause the wavelength-different laser beam to penetrate therethrough better than the connection confirming laser beam. It is noted that the filters 242a and 242b are each formed as, for example, a thin film.

The connection confirming laser beam is emitted from the end face (of the portion F23 that is retained in the second optical connector 22) of the one second optical fiber F2c, reflected at the two inclinations 240a, 240b, and made incident to the end face (of the portion F24 that is retained in the second optical connector 22) of the other second optical fiber F2d.

Next will be described an operation according to the second embodiment.

The first optical connector 12 and the second optical connector 22 are connected such that the second optical fibers F2a, F2b, F2c, F2d and the first optical fibers F1a, F1b, F1c, F1d are connected, and the wavelength-different laser beam is transmitted between the semiconductor test apparatus 100 and the optical probe 200, as is the case in the first embodiment. It is noted that the wavelength-different laser beam penetrates the transparent members 110, 210, the filters 122a, 122b, the filters 222a, 222b, and the filters 242a, 242b.

Further, a connection confirming laser beam (with a wavelength of 1.5 μm) output from the 1.5-μm LD 14 is introduced through the connection confirming laser beam introducing section 15 into the introduction optical fiber (first optical fiber F1a in FIG. 2).

The connection confirming laser beam then passes through the transparent member 110, F11, and F21 to be made incident to the plane 220c of the prism 220, reflected at the two inclinations 220a, 220b, and made incident to the end face (of the portion F22 that is retained in the second optical connector 22) of the other second optical fiber F2b.

The connection confirming laser beam then passes through F22 and F12 to be made incident to the plane 120c of the prism 120, reflected at the two inclinations 120a, 120b, and made incident to the end face (of the portion F13 that is retained in the first optical connector 12) of the other intermediate optical fiber F1c.

The connection confirming laser beam then passes through F13 and F23 to be made incident to the plane 240c of the prism 240, reflected at the two inclinations 242a, 242b, and made incident to the end face (of the portion F24 that is retained in the second optical connector 22) of the other second optical fiber F2d.

The connection confirming laser beam then passes through F24, F14, and the transparent member 110 and reaches the connection confirming laser beam extracting section 17. The optical power of the connection confirming laser beam extracted through the connection confirming laser beam extracting section 17 is measured by the 1.5-μm PD 16 and the result is provided to the connection determining section 18. The connection determining section 18 determines whether or not the connection between the first optical connector 12 and the second optical connector 22 is non-defective based on the ratio between the measurement result and the optical power of the output from the connection confirming laser beam source 14.

The connection determining section 18 determines whether or not the connection is non-defective, as is the case in the first embodiment.

The second embodiment exhibits the same advantageous effects as the first embodiment.

### <Variation>

As a variation of the second embodiment, the first connection confirming laser beam providing section and the second connection confirming laser beam providing sections may concurrently employ a wavelength division multiplexing coupler-based one (as in the first embodiment) and a prism-based one (as in the second embodiment).

That is, it is conceivable to replace the first connection confirming laser beam providing section (prism 120, filters 122a, 122b) according to the second embodiment with one similar to that in the first embodiment. It is also conceivable to replace one or both of the first one of the second connection confirming laser beam providing sections (prism 220, filters 222a, 222b) and the second one of the second connection confirming laser beam providing sections (prism 240, filters 242a, 242b) according to the second embodiment with one similar to that in the first embodiment.

DESCRIPTION OF REFERENCE NUMERALS

| | |
|---|---|
| 100 | Semiconductor Test Apparatus |
| F1a, F1b, F1c, F1d, F1e, F1f | First Optical Fibers |
| F11, F12, F13, F14 | Portions retained in First Optical Connector 12 |
| F1a | Introduction Optical Fiber |
| F1d (in FIG. 1, FIG. 2 and FIG. 3) | Extraction Optical Fiber |
| F1b (in FIG. 4 and FIG. 7) | Extraction Optical Fiber |
| F1f (in FIG. 5 and FIG. 6) | Extraction Optical Fiber |
| 12 | First Optical Connector |
| 14 | 1.5-μm LD (Connection Confirming Laser Beam Source) |
| 15 | Connection Confirming Laser Beam Introducing Section |
| 16 | 1.5-μm PD (Connection Confirming Laser Beam Detector) |
| 17 | Connection Confirming Laser Beam Extracting Section |
| 18 | Connection Determining Section |
| 19a, 11a | One First Wavelength Division Multiplexing Coupler |
| 19b, 11b | Other First Wavelength Division Multiplexing Coupler |
| 19c, 11c | Optical Fiber |
| F2a, F2b, F2c, F2d, F2e, F2f | Second Optical Fiber |
| F21, F22, F23, F24 | Portions retained in Second Optical Connector 22 |
| 22 | Second Optical Connector |
| 23 | Probe Card |
| 24a, 26a, 28a | One Second Wavelength Division Multiplexing Coupler |
| 24b, 26b, 28b | Other Second Wavelength Division Multiplexing Coupler |
| 222a, 222b, 242a, 242b | Filter |
| 200 | Optical Probe |
| 300 | DUT |

What is claimed is:

1. An optical connector connection determining apparatus, comprising:
a first optical connector that retains first optical fibers;
a second optical connector that retains second optical fibers to be connected with the first optical fibers and that is arranged to be connected with the first optical connector;
a connection confirming laser beam source arranged to output a connection confirming laser beam to be used to confirm a connection between the first optical connector and the second optical connector;
a connection confirming laser beam introducing section arranged to introduce the connection confirming laser beam into an introduction optical fiber, which is one of the first optical fibers;
a connection confirming laser beam extracting section arranged to extract the connection confirming laser beam from an extraction optical fiber, which is one of the first optical fibers other than the introduction optical fiber;
a connection determining section arranged to determine whether or not the connection between the first optical connector and the second optical connector is non-defective based on the connection confirming laser beam extracted through the connection confirming laser beam extracting section;
a first connection confirming laser beam providing section arranged to receive the connection confirming laser beam from one intermediate optical fiber and provide to an other intermediate optical fiber, which are each one of the first optical fibers but not the introduction optical fiber or the extraction optical fiber; and
a second connection confirming laser beam providing section arranged to receive the connection confirming laser beam from one of the second optical fibers and provide to another one of the second optical fibers, wherein
the connection confirming laser beam passes through all of portions of the first optical fibers that are retained in the first optical connector and all of portions of the second optical fibers that are retained in the second optical connector.

2. The optical connector connection determining apparatus according to claim 1, wherein
a wavelength-different laser beam with a wavelength different from that of the connection confirming laser beam also passes through the first optical fibers and the second optical fibers.

3. The optical connector connection determining apparatus according to claim 2, wherein
the connection confirming laser beam introducing section is arranged to multiplex the connection confirming laser beam and the wavelength-different laser beam, and
the connection confirming laser beam extracting section is arranged to demultiplex the connection confirming laser beam and the wavelength-different laser beam.

4. The optical connector connection determining apparatus according to claim 3, wherein
the connection confirming laser beam introducing section and the connection confirming laser beam extracting section are wavelength division multiplexing couplers.

5. The optical connector connection determining apparatus according to claim 2, wherein
the first connection confirming laser beam providing section has:
one first wavelength division multiplexing coupler mounted to the one intermediate optical fiber and arranged to demultiplex the connection confirming laser beam and the wavelength-different laser beam; and
another first wavelength division multiplexing coupler mounted to the other intermediate optical fiber and arranged to multiplex the connection confirming laser beam and the wavelength-different laser beam, wherein
the connection confirming laser beam demultiplexed through the one first wavelength division multiplexing coupler is provided to the other first wavelength division multiplexing coupler.

6. The optical connector connection determining apparatus according to claim 2, wherein
the first connection confirming laser beam providing section has:
a prism having a plane in contact with an end face of the one intermediate optical fiber and an end face of the other intermediate optical fiber, and two inclinations that intersect the plane and each other; and
a filter mounted to the inclinations and arranged to cause the wavelength-different laser beam to penetrate therethrough better than the connection confirming laser beam, wherein
the connection confirming laser beam is emitted from the end face of the one intermediate optical fiber, reflected at the two inclinations, and made incident to the end face of the other intermediate optical fiber.

7. The optical connector connection determining apparatus according to claim 2, wherein
the second connection confirming laser beam providing section has:
one second wavelength division multiplexing coupler mounted to the one second optical fiber and arranged to demultiplex the connection confirming laser beam and the wavelength-different laser beam; and
an other second wavelength division multiplexing coupler mounted to the other second optical fiber and arranged to multiplex the connection confirming laser beam and the wavelength-different laser beam, wherein
the connection confirming laser beam demultiplexed through the one second wavelength division multiplexing coupler is provided to the other second wavelength division multiplexing coupler.

8. The optical connector connection determining apparatus according to claim 2, wherein
the second connection confirming laser beam providing section has:
a prism having a plane in contact with an end face of the one second optical fiber and an end face of the other second optical fiber, and two inclinations that intersect the plane and each other; and
a filter mounted to the inclinations and arranged to cause the wavelength-different laser beam to penetrate therethrough better than the connection confirming laser beam, wherein
the connection confirming laser beam is emitted from the end face of the one second optical fiber, reflected at the two inclinations, and made incident to the end face of the other second optical fiber.

9. The optical connector connection determining apparatus according to claim 1, wherein
the one intermediate optical fiber and the other intermediate optical fiber are adjacent to each other.

10. The optical connector connection determining apparatus according to claim 1, wherein
the one second optical fiber and the other second optical fiber are adjacent to each other.

11. The optical connector connection determining apparatus according to claim 2, wherein
the first optical fibers are connected to a test apparatus,
the second optical fibers are connected to an optical probe, and
the wavelength-different laser beam is transmitted between the test apparatus and the optical probe.

12. The optical connector connection determining apparatus according to claim 1, wherein
the first optical connector and the second optical connector each have an MT ferrule.

13. The optical connector connection determining apparatus according to claim 1, wherein
the connection determining section is arranged to determine whether or not the connection between the first optical connector and the second optical connector is non-defective based on a ratio between an optical power of an output from the connection confirming laser beam source and an optical power of the connection confirming laser beam extracted through the connection confirming laser beam extracting section.
